(19) United States
(12) Patent Application Publication
(10) Pub. No.: US 2024/0190691 A1
(43) Pub. Date: Jun. 13, 2024

(54) Container, keg, system and method for storing and dispensing a beverage

(71) Applicant: The Udder Way I.P. Pty Ltd

(72) Inventor: Edward Crick, Launceston (AU)

(21) Appl. No.: 18/286,092

(22) PCT Filed: Apr. 8, 2022
(86) PCT No.: PCT/AU2022/050317

§ 371 Date: Oct. 6, 2023

(30) Foreign Application Priority Data
Apr. 9, 2021 (AU) 2021901039
Dec. 14, 2021 (AU) 2021904055

(51) Int. Cl. B67D 1/00; B65D 1/18; B65D 1/20; B65D 21/02; B65D 25/28; B67D 1/04; B67D 1/08

(52) U.S. Cl. CPC B67D 1/0004; B65D 1/18; B65D 1/20; B65D 21/0215; B65D 25/2897; B67D 1/04; B67D 1/0802; B67D 1/0804; B67D 1/0831

(57) ABSTRACT

A generally cuboid-shaped container having general footprint dimensions of a milk crate and an aperture configured to receive an input valve for introducing pressurised gas into the container such that milk stored therein can be dispensed under pressure, and an output valve for dispensing milk from the container, the output valve being attachable to a tube positionable in the container to extract milk therefrom, the aperture being closable to facilitate storage and transportation of the milk.

The entire contents of the patent specifications of Australian provisional patent application nos. 2021901039 and 2021904055 are incorporated herein by reference.

### FIELD OF THE INVENTION

The invention relates to containers, kegs, systems and methods for providing, storing and dispensing a beverage.

### BACKGROUND

Given the delicate, perishable and easily contaminated nature of milk, industry bodies such as Dairy Australia and statutory authorities such as Food Standards Australia New Zealand seek to develop standards and/or regulations relating to the safe handling, storage, distribution, transportation, consumption etc. of milk.

Modern industry and safety standards are thus biased toward systems and methods that utilise single-use and dispensable containers. The prospect of milk being spoiled also inclines systems and methods to utilise relatively low volume milk containers, such as 2-litre bottles and small bladders.

The inventor has identified inefficiencies in the processes of providing, transporting, storing, and dispensing milk, particularly for high volume beverage outlets such as at restaurants, hospitals, cafés and canteens.

In this context, there is a need for improved containers, systems and methods for transporting, storing and/or dispensing milk.

### SUMMARY

According to a first aspect of the present invention, there is provided a generally cuboid-shaped container having general footprint dimensions of a milk crate and an aperture configured to receive an input valve for introducing pressurised gas into the container such that milk stored therein can be dispensed under pressure, and an output valve for dispensing milk from the container, the output valve being attachable to a tube positionable in the container to extract milk therefrom, the aperture being closable to facilitate storage and transportation of the milk.

In certain embodiments, the container is between about 250 mm and 250 mm wide and between about 300 mm and 400 mm deep. For example, the container may be about 300 mm wide and about 350 mm deep. It is envisaged that the container may have a volume of between about 17 litres and about 21 litres.

The container may further comprise a spout extending upwardly from a top face of the container, the spout comprising said aperture. The spout may comprise a circumferentially extending lip configured to releasably engage a closure in a snap-fitting manner to close the aperture.

A bottom of the container may comprise an indent configured to receive the spout of a like container upon which it is stacked. A top face of the container may comprise one or more recesses and a bottom of the container may comprise one or more downwardly extending feet, the or each foot being configured to be received by a respective recess of a like container upon which it is stacked. The or each downwardly extending foot may define a well in a bottom interior surface of the container in which milk can collect, and from which milk can be extracted via arrangement of a distal end of the tube adjacent to or in the well(s).

In embodiments of the container, internal surfaces thereof are tapered to facilitate drainage and cleaning of the container through the aperture. The aperture of the container may be elliptical.

According to a second aspect of the present invention, there is provided a keg for dispensing a beverage, comprising:
a container according to a first aspect of the present invention; and
a dispenser fitting receivable in the aperture of the container, the dispenser fitting comprising the input valve and the output valve and a lid for closing the aperture, the input and output valves being fitted to the lid such that in use, with the lid closing the aperture, pressurised gas can be introduced into the container through the lid via the input valve and milk can be extracted from the container through the lid and dispensed via the output valve.

In embodiments of the keg, the lid comprises an elliptical cover receivable through the aperture of the container such that when the pressurised gas is supplied to the container, the cover is urged upwardly against an inner surface of the container to seal the aperture. The lid of the dispenser fitting may be in the form of a Cornelius keg lid. In certain embodiments, the input and output valves at least partially extend through the lid.

In certain embodiments, the keg also comprises a tube that is configured to be, in use, immersed in the milk and in fluid communication with the output valve so as to facilitate dispensing of milk therethrough. A distal end of the tube may be weighted such that, in use, the distal end of the tube sits on a bottom interior surface of the container. In one example configuration, the tube is formed from a first tubular portion that is substantially transparent and securable to the output valve, and a second tubular portion securable to and in fluid communication with the first tubular portion, the second tubular portion defining the weighted distal end of the tube and terminating in a milk inlet end via which milk can enter the tube.

According to a third aspect of the present invention, there is provided a system for dispensing a beverage, comprising:
a keg according to a second aspect of the present invention;
a refrigerator configured to store the keg while in use, the refrigerator comprising a gas port and an output port;
a gas conduit configured to be received in the gas port and to be connected at one end to a gas compressor and at another end to said input valve; and
an output conduit configured to be received in the output port and connected at one end to a dispenser and at another end to said output valve.

According to a fourth aspect of the present invention, there is provided a method of providing, storing and dispensing a beverage using a container according to a first aspect of the present invention, the method comprising:
filling the container with milk and sealing the aperture with a closure;
transporting the container to a user;
removing the closure and connecting the input valve and the output valve via the aperture;
introducing pressurised gas into the container via the input valve; and
dispensing the milk via the output valve.

It certain embodiments of the method, said introduction of pressurised gas into the container and said dispensing of the milk via the output valve are performed while said container is refrigerated.

### BRIEF DESCRIPTION OF THE DRAWINGS

An embodiment of the invention will now be described, by way of example only, with reference to the accompanying drawings in which:

FIG. 1 is a top perspective view of an embodiment of a keg for dispensing a beverage contained therein, the keg comprising a container and a dispenser fitting;

FIG. 2 is a top perspective view of the container of the keg of FIG. 1;

FIG. 3 is a bottom perspective view of the container of FIG. 2;

FIG. 4(a) is a cross-sectional front perspective view of the container of FIG. 2;

FIG. 4(b) is a close-up cross-sectional view of a top face of the container of FIG. 4(a);

FIG. 5 is a perspective view of the dispenser fitting of the keg of FIG. 1;

FIG. 6 is a partial cutaway top perspective view of the keg of FIG. 1;

FIG. 7 is a close-up bottom perspective view inside the keg showing a lid of the dispenser fitting of FIG. 5 closing an aperture of the container of FIG. 2; and

FIG. 8 schematically illustrates an embodiment of a beverage dispensing system with clean-in-place facilities.

### DETAILED DESCRIPTION

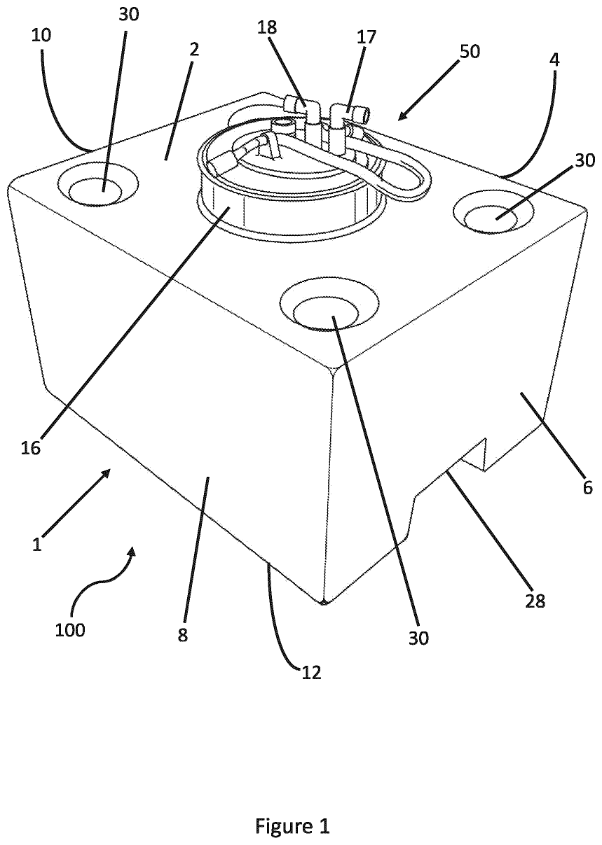

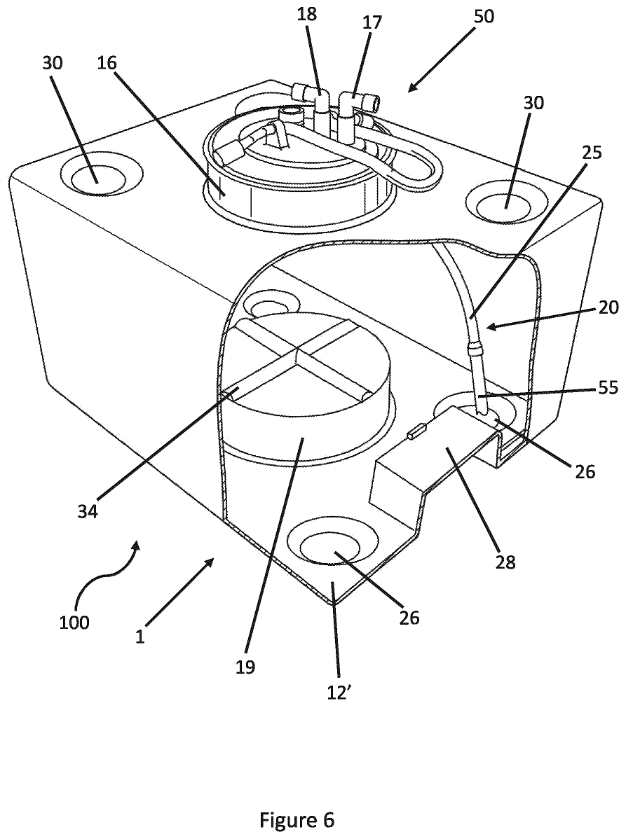

FIGS. 1 and 6 illustrate a keg 100 for storing and dispensing a beverage. In one application, the keg 100 is used to store and dispense milk in a beverage retail outlet.

The keg 100 comprises a container 1 and a dispenser fitting 50. The container 1 is defined by a top face 2, side faces 4, 6, 8, 10 and a bottom face 12.

The container 1 has the overall form of a cuboid or rectangular prism, although there may be minor indentations, protrusions, curvatures, etc., as described in further detail below, that do not detract from this overall form. The cuboidal configuration of the container 1 is of importance, particularly where it is used to store milk, as it approximates the shape and/or size of the footprint of a standard milk crate and may therefore be incorporated relatively seamlessly into existing infrastructure and processes of dairy processing plants, in milk transportation and storage facilities, and at beverage retail outlets. Further, as will be described, the shape facilitates secure and stable stacking of the containers 1 upon one another to facilitate storage and transportation thereof.

Accordingly, the container 1 has general footprint dimensions of a milk crate. For example, the container 1 may be between about 250 mm and 350 mm wide and between about 300 mm and 400 mm deep. In a preferred embodiment, the footprint of the container 1 is about 290 mm by about 350 mm, being slightly smaller in width than a milk crate to allow it to fit easier in fridges.

The height of the cuboid shape of the container 1 may vary depending on volumetric requirements. In one embodiment, the height of the container 1 is between about 170 mm and 270 mm, preferably about 213 mm. In this embodiment, the volumetric capacity of the container 1 may be between about 17 litres and about 21 litres, preferably about 18 litres. This capacity is comparable to that of a standard milk crate, which holds nine 2-litre bottles of milk. When used to store milk, the 18-litre container 1 weighs about 20.5 kg when full, ensuring that the container 1 may still be carried with relative ease. In another embodiment, the container 1 has half the volumetric capacity, i.e., 9 litres, but the footprint of the container 1 remains substantially the same (i.e., about 300 mm by about 350 mm).

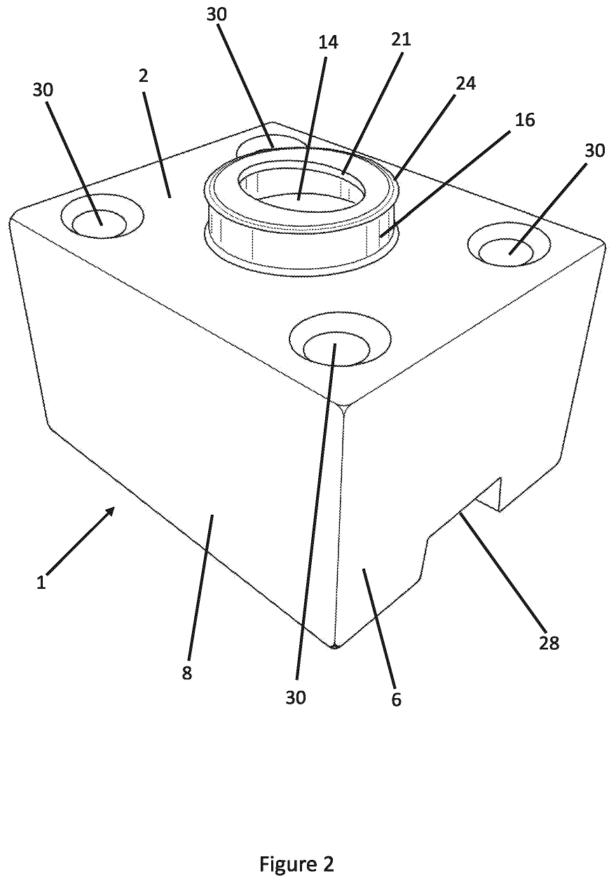

Referring to FIG. 2, the container 1 comprises an aperture 14 through which the beverage can be dispensed. The aperture 14 may also be used to fill, refill, wash and/or dry the container 1. The aperture 14 may be sufficiently large to permit visual inspection of the inside of the container 1, including at least the internal sidewalls and floor thereof. Preferably, the aperture 14 is sufficiently large such that one's hand, or at least cleaning and/or testing equipment can be inserted through the aperture 14 to clean and/or test the cleanliness of the container 1. For example, dairies and the like that rely on swab tests to maintain milk safety and hygiene standards can readily swab internal surfaces of the container 1 through the aperture 14.

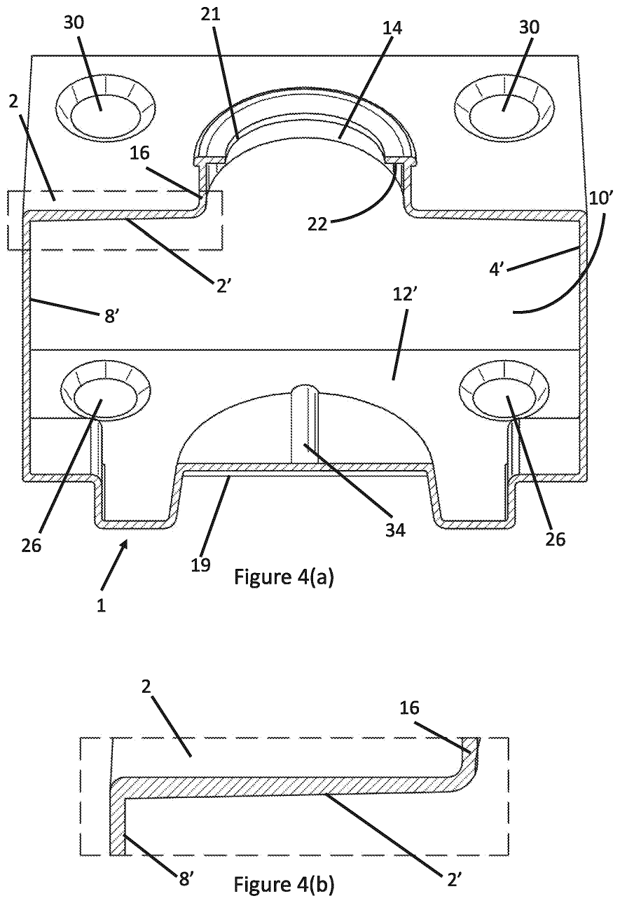

In the depicted embodiment, a spout 16 extends upwardly from the top face 2 of the container 1 and comprises the aperture 14. In preferred embodiments, the spout 16 is configured to receive or engage the dispenser fitting 50. To this end, the spout comprises an inwardly extending radial lip 21 (e.g., see FIG. 4(a)). The internal circumference of the lip 21 defines the aperture 14 of the container 1. An underside of the lip 21 defines an internal collar 22 configured as an abutment or engagement surface for the dispenser fitting 50, as will be discussed.

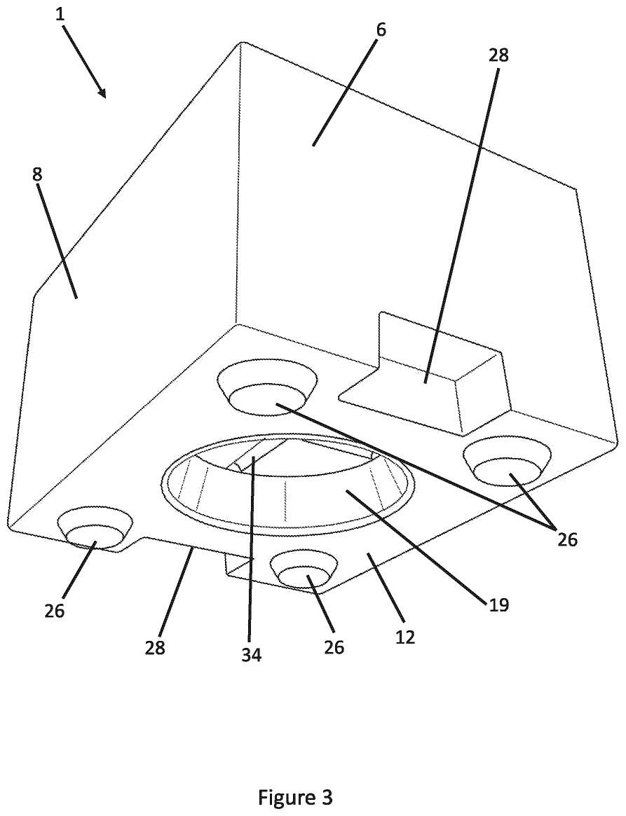

Referring to FIGS. 3 and 6, the bottom face 12 of the container 1 comprises an indent 19 configured to receive the upwardly extending spout 16 of another container 1 upon which it is stacked for secure and efficient stacking. The indent 19 may be provided with reinforcing ribs 34 to increase a strength of the bottom 12 and/or the indent 19 of the container 1 to help withstand the repeated pressurisation that the container 1 is subjected to.

The container 1 may further comprise one or more downwardly extending feet 26 to facilitate stable stacking of the containers 1. In preferred embodiments, the container 1 comprises four such feet 26. The four feet 26 may be defined in and disposed adjacent respective corners of the bottom face 12 of the container 1. With reference to FIG. 2, the top face 2 of the container 1 comprises correspondingly positioned and shaped recesses 30 configured to receive respective feet 26 from a container 1 stacked thereon. As such, secure stacking of containers 1 is facilitated not only by reception of the spout 16 of one container 1 into the lower indent 19 of a container 1 stacked thereon, but also by reception of the feet 26 of the upper container 1 into respective recesses 30 in the top face 2 of the lower container 1. The container 1 may also comprise handles 28 defined, e.g., moulded, into the bottom face 12 and/or side faces 4, 6, 8, 10, to facilitate carrying and stacking of the containers 1.

The aperture 14 of the container 1 is configured to receive an input valve for introducing pressurised gas into the container 1 to dispense the beverage therefrom. In preferred embodiments, particularly where the beverage is milk, the gas is compressed air generated by a tabletop or portable compressor. A hose or similar conduit connects the source of pressurized gas to the input valve. Although other pressurised gases such as nitrogen or carbon dioxide may be used, it has been found that compressed air is ideal for use with milk as it does not have any undesirable effects on milk under pressure and does not require an additional supply of a consumable gas. The dispensing pressure may be between about 100 kPa to about 140 kPa, preferably around 117 kPa. The aperture 14 is also configured to receive an output valve via which the beverage can be dispensed from the container 1.

It is envisaged that at least some of the internal surfaces of the container 1 may be tapered so as to promote drainage of liquid from the container 1 toward the aperture 14. For example, it is envisaged that the internal surfaces of the container 1 may be sufficiently sloped such that, when the container 1 is held upside down (i.e., with the aperture 14 facing towards the ground), liquid would naturally flow, under the influence of gravity, along the sloped surfaces and toward the aperture 14. For example, with reference to FIGS. 4(a) and 4(b), at least the internal upper surface 2′ of the container 1 slopes toward the aperture 14 to promote drainage theretoward. While not visible from FIG. 4(a), one or more of the internal sidewalls 4′, 8′, 10′ and/or the bottom wall 12′ of the container 1 may have an outward bulge or curvature such that these interior walls of the container 1 define respective convex surfaces. This convex form provides a smooth and continuous interior surface that can be easily visually inspected and/or cleaned. This is contrast to containers or kegs with relatively sharp edges and corners in which gunk may collect, which internal edges and corners may not be easy to access or clean without more expensive and/or specialist equipment and processes. While further features of the container 1 will be described, it will be appreciated that a preferable embodiment of the present container 1 is one wherein the interior thereof is substantially defined by relatively smooth and/or curved surfaces to permit easy inspection and cleaning of the inside of the container 1.

Unlike the relatively simple construction of the present container 1, known kegs have additional structures and openings configured to be fitted with input and output valves and tubing to facilitate the pressurisation of the kegs and beverage dispensing therefrom. Such structures and openings of known kegs, along with the associated dispenser fittings, tubing and the keg itself, may be relatively difficult to visually inspect, clean and/or test for cleanliness (e.g., via a swab test), and thus may not satisfy the various milk safety standards and regulations required of milk containers before they can be used (let alone reused) to store milk for human consumption. As such, known kegs are rejected by dairies and the like because such kegs cannot be reliably and/or efficiently tested for hygiene and cleanliness.

The present keg 100 does not suffer the cleanliness and hygiene drawbacks faced by common kegs. As previously discussed, the container 1 of the present keg 100, and particularly the interior thereof, is configured such that it is easy to visually assess, clean and test for cleanliness. The container 1 is not configured with relatively complicated, small or otherwise hard to test/clean/see structures, features or openings, and thus dairies can readily ascertain the cleanliness of the present containers 1. Indeed, peak dairy bodies (including Dairy Australia) have authorised the present containers 1 for reusably storing milk.

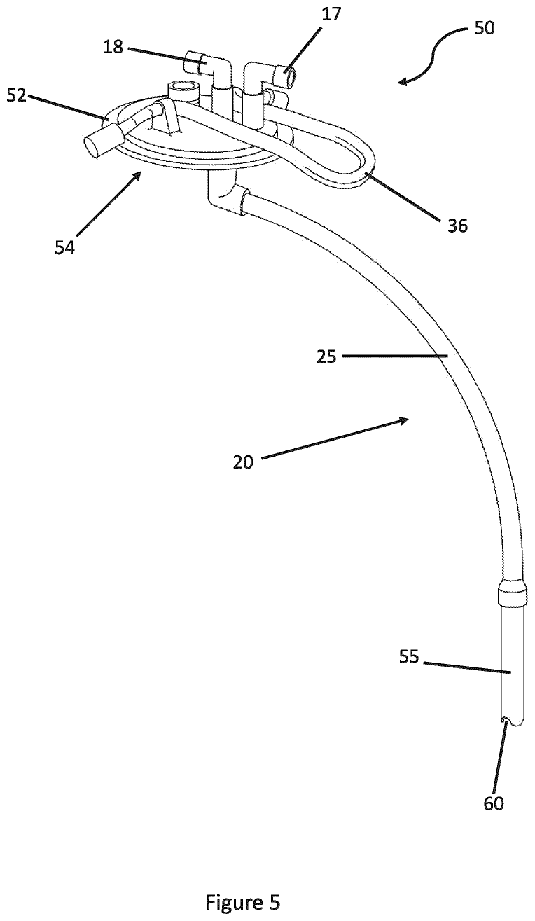

To achieve the present container 1 which can function as part of a keg 100, the container 1 is configured to be fitted with a dispenser fitting 50 which is separable from the container 1. FIG. 5 shows the dispenser fitting 50 of the keg 100. The dispenser fitting 50 functions not only to close the aperture 14 of the container 1, but also facilitates the introduction of compressed gas into the container 1 and dispensing of the beverage therefrom. To this end, the depicted dispenser fitting 50 comprises a lid 54 for closing the aperture 14, as well as an input valve 17 and an output valve 18. The input valve 17 and the output valve 18 are each fitted to the lid 54 such that, in use, when the dispenser fitting 50 is fitted to the container 1 such that the lid 54 fluidically seals the aperture 14, pressurised gas can be introduced into the container 1 through the lid 54 via the input valve 17 and the beverage can be extracted from the container 1 through the lid 54 and dispensed via the output valve 18. In the depicted embodiment, the input and output valves 17, 18 extend through the lid 54 of the dispenser fitting 50 such that in use, the valves 17, 18 protrude through the aperture 14 of the container 1.

In a preferred embodiment, the lid portion 54 of the dispenser fitting 50 is generally in the form of and functions like a Cornelius keg lid (i.e., the type of lids used to seal Cornelius kegs). However, while Cornelius keg lids commonly have a metal body and are used to close metallic Cornelius kegs containing carbonated beverages, the lid 54 of the present dispenser fitting 50 is preferably formed from a relatively rigid plastic. For example, the lid 54 may be formed from a freezer grade plastic suited to the refrigerated environments in which the keg may be stored. The lid 54 has a generally elliptical form and comprises an elliptical collar 52 configured to carry thereon a correspondingly shaped sealing ring (not shown). Similar to a Cornelius keg lid, the present lid 54 also comprises a handle or lever 36 that is manually pivotal to operate the lid 54 to effect opening and closing of the aperture 14 of the container 1.

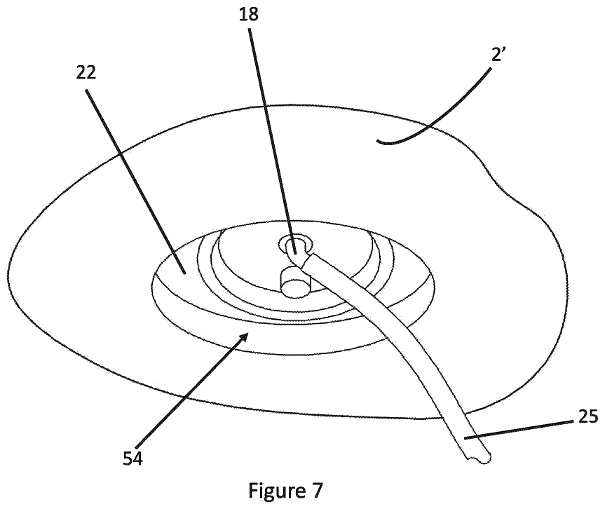

Referring to FIG. 2, in preferred embodiments, the aperture 14 of the container 1 is generally elliptical. Referring to FIG. 5, the lid 54 and sealing O-ring of the dispenser fitting 50 is also generally elliptical, though larger than the ellipse circumscribed by the aperture 14. To fit the dispenser fitting 50 to the container 1, the lid 54 can first be held generally level above the aperture 14 and oriented so that the major axis of the elliptical lid 54 is offset from the major axis of the elliptical aperture 14. For example, the respective major axes could be perpendicular to one another. One of the two opposed longer ends of the elliptical lid 54 can then be tilted downwardly into and through the aperture 14, thereby permitting the entire elliptical lid 54 to be inserted through the aperture 14 and into the container 1. The lid 54 can then be aligned with the elliptical aperture 14 such that their respective major axes are substantially aligned with one another. The lid 54 can then be pulled upwardly such that it engages against the interior collar 22 of the spout 16. As such, the O-ring of the lid 54 engages against the abutment surface defined by the interior collar 22. Finally, the handle 36 of the lid 50 can be levered to urge the lid 54 and thus the sealing ring upwardly into a sealing engagement against the collar 22 of the spout 16, as shown in FIG. 7, so as to fluidically seal the aperture 14.

Referring to FIGS. 5 and 6, the output valve 18 is configured to be attached to, or at least in fluid communication with, a tube 20 that is positioned, in use, within the container 1 to extract the beverage therefrom. The other end of the output valve 18 is configured to be connected to a dispenser head (not shown) via a hose or similar conduit. Flow through the output valve 18 to the dispenser head may be controlled via any suitable mechanism such as a tap, clamp, lever locking mechanism, etc.

The depicted tube 20 comprises two tubular portions 25, 55 in fluid communication with one another. A first tubular portion 25 of the tube 20 is substantially transparent and formed from a flexible material, such as a relatively soft plastic or rubber. An upper end of this transparent portion 25 is secured to the dispenser fitting 50, either directly or indirectly via the output valve 18. The second tubular portion of the tube 20 may comprise a metallic end fitting 55. The end fitting can be joined to the first tubular portion 25 by, for example, urging the metallic end fitting 55 into the opening of the first portion 25. The second portion 55 is configured to function as a weight or anchor so that the tube 20 sits or rests on the floor 12′ of the container 1 and is able to more completely extract milk from inside the container 1.

Referring to FIGS. 4 and 6, the four feet 26 define small wells 26 in respective corners of the floor 12′ of the container 1. Milk may thus collect in one or more of these wells 26. Advantageously, and with reference to FIG. 6, the weighted tubular end fitting 55 is configured to sit adjacent or in the well of a foot 26 and thus extract milk therefrom, thereby reducing milk wastage. Referring to FIG. 5, it will be appreciated that the weighted tubular portion 55 of the tube 20 defines a milk inlet end 60 via which milk enters the tube 20. Although the weighted portion 55 is substantially cylindrical, opposed walls at the inlet end of the weighted tube are recessed such that, when viewed from one side, the milk inlet end 60 has a C-shaped mouth. Referring to FIG. 6, this ensures that even if the milk inlet end 60 sits directly on a relatively flat surface of the floor 12′ of the container 1, milk is still able to enter the tube 20 since the C-shaped mouth prevents the milk inlet end 60 from sitting flush on the floor 12′ of the container 1.

In use, the dispenser fitting 50, along with associated tubing and other fittings, may be provided to and maintained and cleaned by the end-user (e.g., a beverage retail outlet, such as a café), whereas the container 1 is transported back-and-forth between a dairy (for refilling with milk) and the end-user (for dispensing of milk). The container 1 may therefore be closed with a simple closure, such as a lid, cover or cap (not shown) for transportation and storage. The cap may be attached to the spout 16 via an interference fit. For example, with reference to FIG. 2, the spout 16 comprises an outwardly extending circumferential lip 24 and the cap may comprise a correspondingly shaped and sized circumferential groove or recess configured to reversibly receive the lip 24 of the spout 16 to facilitate closing and opening of the aperture 14 via application and removal of the cap. The end-user may also be provided with a funnel that can be snap-lockingly secured to the spout 16. If for whatever reason the dispenser fitting 50 and/or associated components of the keg system are not functioning or available (e.g., the café has run out of compressed gas), the funnel can be fitted to the spout 16 and the container 1 may be oriented upside-down such that the milk therein can still be dispensed from the container 1 via the funnel.

While a threaded engagement between the spout 16 and a closure for closing the aperture 14 is within the scope of the present specification, it has been found that gunk can collect in the screw thread and thus cleaning of the threaded spout 14 and corresponding closure may be more difficult. The dispenser fitting 50 is easily washed at the end-user premises (an example process for cleaning the dispenser fitting 50 is described below) and can be reused with multiple containers 1.

The container 1 is preferably manufactured of a plastic material such that it is suitably lightweight yet substantially rigid and durable, and able to be washed, sterilised and reused multiple times. Preferably, the container 1 is recyclable at end of life. The container 1 may be rotationally moulded from high-density polypropylene and rated to be reused for up to eight years. Alternatively, the container 1 may be manufactured of a metal or metallic alloy such as stainless steel.

The container 1 may be provided with a tracking tag (not shown), for example, a barcode, a radio frequency identification (RFID) tag, a quick response (QR) code, etc., to facilitate identification, tracking and inventory management.

A method of storing and dispensing a beverage using the container 1 and associated dispenser fitting 50 will now be described using the example of supplying milk to a café.

The container 1 is first filled (or refilled) at a dairy processing plant and sealed with a removable cover, lid or cap (not shown) before being transported to the café. As described above, because the container 1 is of the approximate size and shape of a milk crate, it fits into existing infrastructure at these facilities and eliminates the need for separate milk crates.

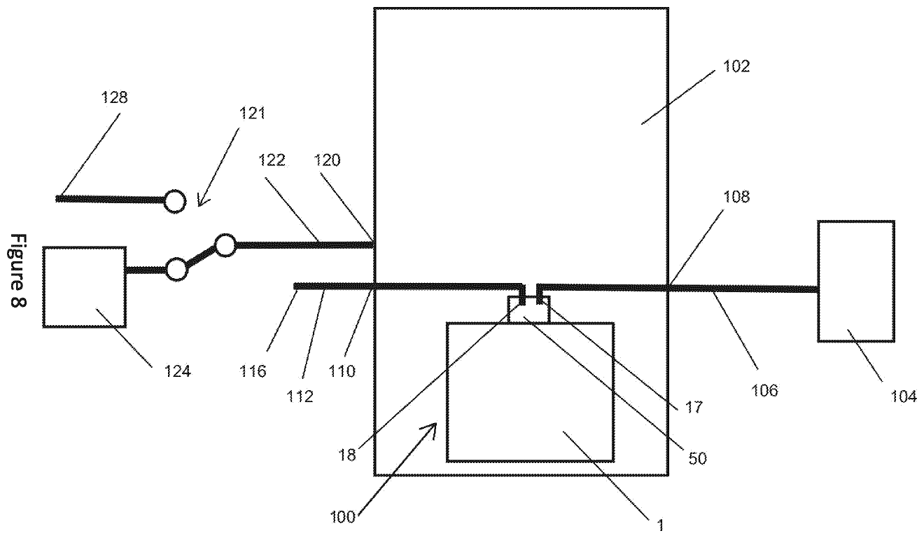

At the café, the containers 1 may be stacked and stored in a refrigerator 102. When milk is to be dispensed from a container 1, the cover can be removed, a dispenser fitting 50 fitted, and milk can be dispensed directly from the refrigerated container 1. One embodiment of the end-user infrastructure at the café, including a clean-in-place system for cleaning the dispenser fitting 50, will now be described with reference to FIG. 8. The refrigerator 102 may be an existing refrigerator 102 configured for storing standard milk crates and retrofitted with ports/connectors described below or may be a customised refrigerator 102 provided with such ports.

Compressed gas port 108 is configured to receive a gas conduit 106 connected at one end to compressor 104 and connectable at the other end to the refrigerated keg 100 in use. Output port 110 is configured to receive an output conduit 112 connected at one end to a dispenser 116 for the user to dispense the milk, e.g., directly at a counter or coffee machine, and connectable at the other end to the refrigerated keg 100 in use.

In certain embodiments, cleaning port 120 may be provided and is configured to receive a cleaning conduit 122 selectively connectable (via a switch 121) at one end to a water supply 128 or to a supply of cleaning agent 124, and connectable at the other end the output conduit 112 to clean the conduit 112 and the dispenser 116.

Before use, the cap is removed from the container 1 and the dispenser fitting 50 is fitted to the container 1 via the aperture 14 thereof. The input valve 17 of dispenser fitting 50 is then connected to gas conduit 106 to supply compressed gas to the container 1. The output valve 18 of dispenser fitting 50 is connected to output conduit 112, and therefore to dispenser 116. To dispense the milk, compressed gas from compressor 104 is supplied into the container 1 so that milk is extracted via the tube 20 to flow through output valve 18 and output conduit 112 to dispenser 116.

In certain embodiments, to clean the dispensing subsystem (i.e., the dispenser fitting 50, the output conduit 112 and the dispenser 116), output conduit 112 may be removed from the dispenser fitting 50 and connected to the cleaning port 120 (in embodiments where the cleaning port 120 are provided). The output conduit 112 and dispenser 116 may be cleaned with a cleaning agent from supply 124 and rinsed with water from water supply 128. According to one example cleaning protocol, a cleaning agent is firstly fed through the outlet conduit 112 and dispenser 116, and dispenser 116 is opened to allow the cleaning agent to run through the dispensing line. The dispenser 116 is then shut and the cleaning agent left in the dispensing line for three minutes. The switch 121 is then switched to the water supply 128 and the dispenser 116 opened to allow water to run through and out of the dispensing line to flush the line of any remaining cleaning agents. Dispenser fitting 50 may be removed and cleaned in a dishwasher or manually.

Once milk has been extracted from the container 1, the dispenser fitting 50 is removed from the container 1 and connected to a new container 1. The empty container 1 may be returned to appropriate facilities to be washed and reused or recycled. For example, since the footprint of the container 1 is of a similar size and shape to the footprint of a milk crate, the container 1 may be cleaned using existing crate washing facilities and/or existing cleaning in place (CIP) facilities at dairy processing plants.

It will be appreciated that the container 1 may provide numerous advantages over conventional milk bottles. Instead of a 2-litre capacity, a single container 1 (in preferred embodiments) has a capacity of about 18 litres, resulting in a significant reduction in manufacturing and handling costs. The similarity in size and shape of the container 1 to a conventional milk crate and the stackability of the container 1 ensures that it can be incorporated into existing dairy production, transport, warehousing and storage facilities. At high volume beverage outlets, continuous dispensing from the 18-litre container 1 greatly improves efficiency, reducing the need to store, replace, open and dispose of individual bottles. Further, where the container 1 stays refrigerated in use, for example in refrigerator 102 as described above in relation to FIG. 8, this reduces the risk of contamination and spoilage of the milk, in contrast to conventional settings where individual milk bottles may be left on countertops and at room temperature for several hours.

Substituting nine 2-litre bottles with a single container 1, particularly where the container 1 is also reusable and recyclable, additionally reduces the environmental costs associated with disposing individual conventional milk bottles. Further, in preferred embodiments, the cap for closing the aperture 14 is manufactured of the same material(s) as the container 1 (e.g., polypropylene) and is therefore recyclable at the same facilities for recycling the container 1. In contrast, screw caps of conventional milk bottles and the milk bottles themselves are not recyclable at the same facilities.

While the examples provided above relate to providing, storing and dispensing milk in the containers 1, it is envisaged that the containers 1 could alternatively be used with other beverages such as water, juice, kombucha and alcoholic beverages such as wine, gin and other spirits.

While various embodiments of the present invention have been described above, it should be understood that they have been presented by way of example only, and not by way of limitation. It will be apparent to a person skilled in the relevant art that various changes in form and detail can be made therein without departing from the spirit and scope of the invention. Thus, the present invention should not be limited by any of the above-described exemplary embodiments.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

1. A generally cuboid-shaped container having general footprint dimensions of a milk crate and an aperture configured to receive an input valve for introducing pressurised gas into the container such that milk stored therein can be dispensed under pressure, and an output valve for dispensing milk from the container, the output valve being attachable to a tube positionable in the container to extract milk therefrom, the aperture being closable to facilitate storage and transportation of the milk.

2. The container of claim 1, being between about 250 mm and 350 mm wide and between about 300 mm and 400 mm deep.

3. The container of claim 1, being about 290 mm wide and about 350 mm deep.

4. The container of claim 1, having a volume of between about 17 litres and about 21 litres.

5. The container of claim 1, further comprising a spout extending upwardly from a top face of the container, the spout comprising said aperture.

6. The container of claim 5, wherein the spout comprises a circumferentially extending lip configured to releasably engage a closure in a snap-fitting manner to close the aperture.

7. The container of claim 5, wherein a bottom thereof comprises an indent configured to receive the spout of a like container upon which it is stacked.

8. The container of claim 1, wherein a top face thereof comprises one or more recesses and a bottom of the container comprises one or more downwardly extending feet, the or each foot being configured to be received by a respective recess of a like container upon which it is stacked.

9. The container of claim 8, wherein the or each downwardly extending foot defines a well in a bottom interior surface of the container in which milk can collect, and from which milk can be extracted via arrangement of a distal end of the tube adjacent to or in the well(s).

10. The container of claim 1, wherein internal surfaces thereof are tapered to facilitate drainage and cleaning of the container through the aperture.

11. The container of claim 1, wherein the aperture is elliptical.

12. A keg for dispensing a beverage, comprising:
a container according to any one of the preceding claims; and
a dispenser fitting receivable in the aperture of the container, the dispenser fitting comprising the input valve and the output valve and a lid for closing the aperture, the input and output valves being fitted to the lid such that in use, with the lid closing the aperture, pressurised gas can be introduced into the container through the lid via the input valve and milk can be extracted from the container through the lid and dispensed via the output valve.

13. The keg of claim 12, wherein the lid comprises an elliptical cover receivable through the aperture of the container such that when the pressurised gas is supplied to the container, the cover is urged upwardly against an inner surface of the container to seal the aperture.

14. The keg of claim 12, wherein the lid is in the form of a Cornelius keg lid and the input and output valves at least partially extend therethrough.

15. The keg of claim 12, further comprising a tube that is configured to be, in use, immersed in the milk and in fluid communication with the output valve so as to facilitate dispensing of milk therethrough.

16. The keg of claim 15, wherein a distal end of the tube is weighted such that, in use, the distal end of the tube sits on a bottom interior surface of the container.

17. The keg of claim 16, wherein the tube is formed from a first tubular portion that is substantially transparent and securable to the output valve, and a second tubular portion securable to and in fluid communication with the first tubular portion, the second tubular portion defining the weighted distal end of the tube and terminating in a milk inlet end via which milk can enter the tube.

18. A system for dispensing a beverage, comprising:
a keg according to claim 12;
a refrigerator configured to store the keg while in use, the refrigerator comprising a gas port and an output port;
a gas conduit configured to be received in the gas port and to be connected at one end to a gas compressor and at another end to said input valve; and
an output conduit configured to be received in the output port and connected at one end to a dispenser and at another end to said output valve.

19. A method of providing, storing and dispensing a beverage using a container of claim 1, the method comprising:
filling the container with milk and sealing the aperture with a closure;
transporting the container to a user;
removing the closure and connecting the input valve and the output valve via the aperture;
introducing pressurised gas into the container via the input valve; and
dispensing the milk via the output valve.

20. The method of claim 19, wherein said introduction of pressurised gas into the container and said dispensing of the milk via the output valve are performed while said container is refrigerated.
